(19) United States
(12) Patent Application Publication
(10) Pub. No.: US 2010/0017884 A1
(43) Pub. Date: Jan. 21, 2010

(54) METHOD FOR ALLOWING FULL VERSION CONTENT EMBEDDED IN MOBILE DEVICE AND SYSTEM THEREOF

(75) Inventor: Hyong-Suk Kim, Surrey (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: M-BIZ Global Company Limited, Kingston Upon Thames (GB)

(21) Appl. No.: 12/376,679

(22) PCT Filed: Nov. 13, 2006
(86) PCT No.: PCT/KR06/04748

§ 371 Date: Feb. 6, 2009

(51) Int. Cl. H04L 9/32; G06Q 20/00; G06Q 30/00; G06Q 50/00; H04W 4/12

(52) U.S. Cl. 726/26; 705/34; 705/26; 455/466

(57) ABSTRACT

A method for unlocking full version contents embedded in a mobile device comprises receiving a first signal for requesting the unlocking of full version contents embedded in a mobile device, the full version contents of which permitted usage is initially limited, and sending an unlocking message having an unlocking code for permitting a user to use the full version contents. According to the method and system for unlocking the full version contents, the full version contents are unlocked only after requesting the unlocking, and costs for the full version contents are charged to the user only when the request is allowed. Thus, costs may be saved.

### TECHNICAL FIELD

The present invention relates to a method for unlocking full version contents embedded in a mobile device and a system thereof. More particularly, the present invention relates to a method for unlocking full version contents, of which permitted usage is initially limited as a demo version, embedded in a mobile device, and a system thereof.

### BACKGROUND ART

Conventionally, various contents, such as games, e-learning and e-banking, are embedded in mobile devices, such as cellular phones and personal digital assistants (PDAs). Thus, the user of a mobile device may use basic contents embedded in the mobile device.

Nowadays, mobile device manufacturers prefer to embed high quality contents in mobile devices to stimulate purchasing desire.

As the contents for mobile devices are becoming more complex and various, the mobile device manufacturers have a tendency to embed contents provided by content providers instead of developing contents themselves.

When a mobile device manufacturer embeds contents provided by a content provider, the costs inevitably increase.

As higher numbers of and more various contents are embedded in mobile devices, the costs increase, and unnecessary contents and related costs may be increased as well.

### DISCLOSURE OF THE INVENTION

### Technical Problem

The present invention provides a method and system for saving costs when a mobile device manufacturer embeds contents in a mobile device. Initially, a user of the mobile device typically uses demo version contents. The full version contents are unlocked only after requesting the unlocking of the full version contents, and costs for the full version contents are charged to the user only when the request is allowed.

The present invention provides a method and system for unlocking full version contents embedded in a mobile device, and the method may be conveniently used, and may efficiently provide security and management.

### Technical Solution

Accordingly, the present invention is provided to substantially obviate one or more problems due to limitations and disadvantages of the related art.

In an example embodiment of the present invention, a method for unlocking full version contents embedded in a mobile device comprises: (a) receiving a first signal for requesting the unlocking of full version contents embedded in a mobile device, the full version contents of which permitted usage is initially limited, and (b) sending an unlocking message having an unlocking code for permitting a user to use full version contents.

In another example embodiment of the present invention, a system for unlocking full version contents embedded in a mobile device comprises a mobile device, a server, and a communication network. The mobile device sends a first signal for requesting the unlocking of full version contents, and receives an unlocking message having an unlocking code for using the full version contents, of which permitted usage is initially limited. The server receives the first signal from the mobile device, and sends the unlocking message for using the full version contents. The communication network transmits data between the mobile device and the server.

In still another embodiment of the present invention, a server for unlocking full version contents embedded in a mobile device comprises a memory, a control unit, a storage unit, and a sender/receiver unit. The memory stores a full version content unlocking program. The full version content unlocking program comprises functions of receiving a first signal for requesting the unlocking of full version contents, and sending an unlocking message having an unlocking code for permitting a user to use the full version contents, of which permitted usage is initially limited. The control unit controls the functions of the full version content unlocking program. The storage unit stores control data of the control unit, and data needed for unlocking the full version contents. The sender/receiver unit transmits data through a communication network in response to the control unit.

In still another example embodiment of the present invention, a mobile device comprises a memory, a control unit, a storage unit, a sender/receiver unit, a keypad, and a display unit. The memory stores a full version content management program, the full version content management program comprises functions of sending a first signal for requesting the unlocking of full version contents, and receiving an unlocking message having an unlocking code for permitting a user to use full version contents, of which permitted usage is initially limited. The control unit executes the full version content management program. The storage unit stores the full version contents, control data of the control unit, and data needed for unlocking the full version contents. The sender/receiver unit transmits data through a communication network in response to the control unit. The keypad manipulates a menu for requesting the unlocking of the full version contents. The display unit displays input information of the menu, and the unlocking message for requesting the unlocking of the full version contents.

In still another example embodiment of the present invention, a method for unlocking full version contents embedded in a mobile device comprises: (a) sending a first signal for requesting the unlocking of full version contents embedded in a mobile device, the full version contents of which permitted usage is initially limited; and (b) receiving an unlocking message having an unlocking code for permitting a user to use the full version contents.

In still another example embodiment of the present invention, a processor for unlocking full version contents embedded in a mobile device, comprises: a storage unit being mechanically readable; and program codes stored in the storage unit. The program codes are executed with steps of: (a) receiving a first signal for requesting the unlocking of the full version contents embedded in a mobile device, the full version contents of which permitted usage is initially limited; and (b) sending an unlocking message having an unlocking code for permitting a user to use the full version contents.

### BRIEF DESCRIPTION OF THE DRAWINGS

The above and other advantages of the present invention will become more apparent by describing in detail example embodiments thereof with reference to the accompanying drawings, in which:

FIG. 1 is a flow chart illustrating a method for unlocking full version contents embedded in a mobile device according to an example embodiment of the present invention.

FIG. 2 illustrates screens displayed in a mobile device when a user requests and uses full version contents according to an example embodiment of the present invention.

FIG. 3 is a flow chart illustrating another procedure for unlocking full version contents according to an example embodiment of the present invention.

FIG. 4 illustrates screens displayed in a mobile device for illustrating an interface of a credit card payment system according to an example embodiment of the present invention.

FIG. 5 is a block diagram illustrating a system configuration for unlocking full version contents embedded in a mobile device according to an example embodiment of the present invention.

FIG. 6 is a block diagram illustrating another system configuration for unlocking full version contents embedded in a mobile device according to an example embodiment of the present invention.

FIG. 7 is a block diagram illustrating a configuration of a full version content unlocking server according to an example embodiment of the present invention.

FIG. 8 is a block diagram illustrating a configuration of a mobile device according to an example embodiment of the present invention.

### BEST MODE FOR CARRYING OUT THE INVENTION

Hereinafter, the present invention will be described in detail with reference to the accompanying drawings. In the drawings, like numbers refer to like elements. In case that a detailed description may make the subject matter unclear, the detailed description will be omitted.

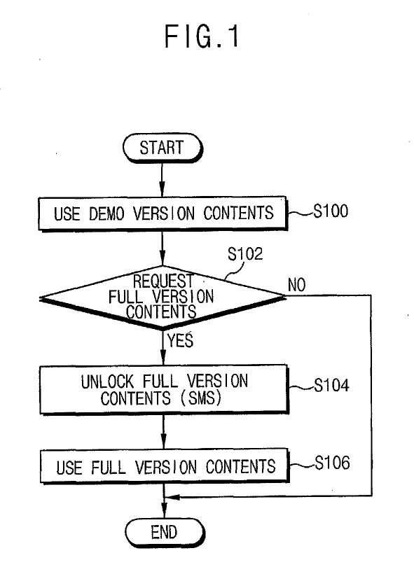

FIG. 1 is a flow chart illustrating a method for unlocking full version contents embedded in a mobile device according to an example embodiment of the present invention.

A mobile device according to an example embodiment of the present invention contains full version contents. However, permitted usage of the full version contents is initially limited, and a user of the mobile device may use only demo version contents. That is, the user may not use all the functions of the full version contents. The user may read a description about the full version contents or use only several functions of the full version contents (step S100).

Herein, a mobile device manufacturer or a content provider may restrict the time for using the demo version contents or functions normally available in the full version contents.

When the user of the mobile device wants to use the full version contents, the user may request an unlocking of the full version contents (step S102). When the user likes the contents after using the demo version contents, the user may request an unlocking of the full version contents.

A full version content unlocking server of the mobile device manufacturer or the content provider may handle the user's request to unlock the full version contents. The full version content unlocking server receives a request for unlocking of the full version contents and permits the user to use the full version contents.

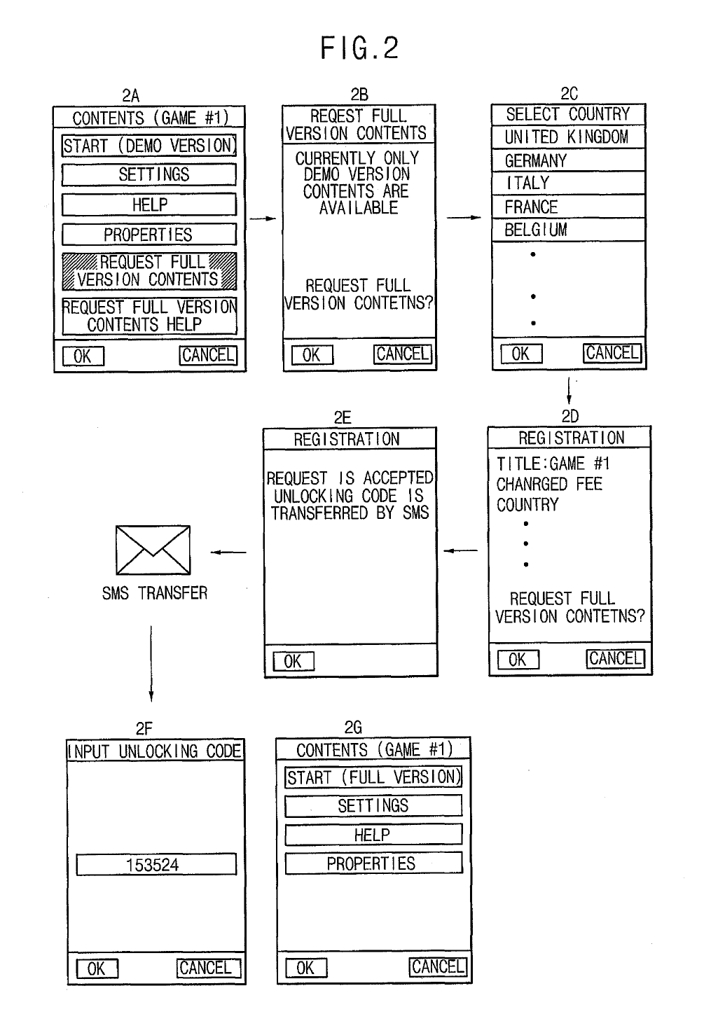

According to an example embodiment of the present invention, the user of the mobile device may conveniently request unlocking of full version contents with the mobile device. This method will be precisely described referring to FIG. 2.

When the full version content unlocking server receives a request to unlock the full version contents, the full version content unlocking server allows the user to use the full version contents (step S104).

According to an example embodiment of the present invention, an unlocking of the full version contents may be performed with a short message service (SMS) message. For example, the full version unlocking server sends the SMS message to the mobile device, and the SMS message may contain an unlocking code for unlocking the full version contents.

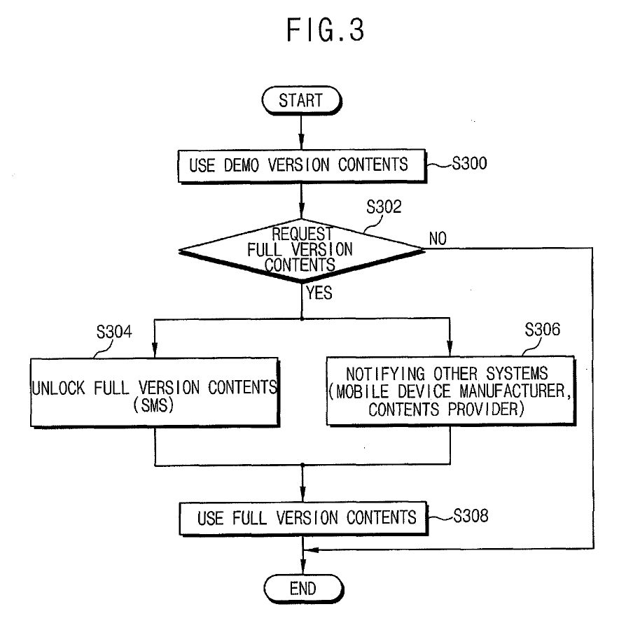

The full version content unlocking server may unlock the full version contents after an additional confirmation, as well as promptly after receiving a request. The full version content unlocking server may notify other systems of some information for billing. This procedure will be precisely described referring to FIG. 3.

When the full version contents are unlocked, the user of the mobile device may use the full version contents having all the functions enabled (step S106). That is, when the unlocking code is required to use the full version contents, the user may use the full version contents after inputting the unlocking code transmitted to the mobile device through the SMS message.

FIG. 2 illustrates screens displayed in a mobile device when a user requests and uses full version contents according to an example embodiment of the present invention.

When the user clicks on a menu for executing specific contents (GAME #1), a new menu as shown in screen 2A is displayed.

When the user clicks REQUEST FULL VERSION CONTENTS in the menu, a confirmation message as shown in screen 2B is displayed.

When the user clicks OK in screen 2B, the user may select a country in a new menu as shown in screen 2C. The country selection menu is provided for selecting a specific language convenient for the user. Various additional menus may be displayed in case that billing systems of various countries are different from one another.

For example, when more than two languages are used in one country, such as in Belgium, the user may select one of the two languages in an additional menu.

When the user selects a country, information for requesting the unlocking and reconfirmation message as shown in screen 2D may be displayed. For example, a game title, a charged fee, and the selected country may be displayed.

When the user confirms the unlocking request, a message notifying that the unlocking request is correctly registered is displayed. The SMS message is transmitted to the mobile device.

The transmitted SMS message may contain an unlocking code for using the full version contents. Security for unlocking the full version contents may be reinforced by requiring the unlocking code contained in the SMS message for using the full version contents. The unlocking code may be 6-digit password as shown in screen 2F or may be modified to various types.

Moreover, the number of times the user inputs incorrect unlocking codes may be limited to a specific number. For example, when the user inputs incorrect unlocking codes three times, an alert message may be displayed or requesting an additional unlocking may be strictly forbidden.

When the user inputs a correct unlocking code, a menu for executing the full version contents as shown in screen 2G is displayed, and the user may use the full version contents thereafter.

FIG. 2 illustrates a case in which the user intentionally requests the unlocking of the full version contents. However, it may be possible that the mobile device automatically displays a full version request menu after a predetermined period, while disabling execution of the full version contents. Implementation with shortcut keys of the mobile device may also be possible.

FIG. 2 illustrates a case in which the unlocking message is transmitted by SMS. The unlocking message, however, may be transmitted by email or various means.

FIG. 3 is a flow chart illustrating another procedure for unlocking full version contents according to an example embodiment of the present invention.

Referring FIG. 3, the procedure for unlocking the full version contents according to an example embodiment of the present invention may be similar to the procedure described with reference to FIG. 2. However, a step of notifying other systems of the unlocking of the full version contents is added.

FIG. 1 illustrates a case in which both requesting and unlocking of the full version contents are performed in a full version unlocking server, and FIG. 3 illustrates a case in which requesting or unlocking of the full version contents are performed cooperatively with other systems with regard to billing.

That is, FIG. 1 illustrates a case for processing the charged fee with only the unlocking of the full version content server and the user of the mobile device. FIG. 3 illustrates a case for processing the charged fee with additional systems for processing the charged fee.

For example, referring to FIG. 1, in the case that the full version unlocking server corresponds to a server of the full version content provider, and the full version content server itself charges the charge fee to the user directly, and the information about the charged fee only needs to be stored within the full version content unlocking server.

However, when all of the systems, including the user of the mobile device, the full version content provider, and the mobile device manufacturer, are related to one another for processing the charge fee, the information regarding the charged fee needs to be transferred from one system to another. That is, in case that the mobile device manufacturer pays for the full version contents only when the user requests unlocking of the full version contents, the information about unlocking the full version contents needs to be provided to the mobile device manufacturer as well.

Additional systems for intervening between the mobile device manufacturer and the full version content provider may be involved. In such a case, all of the systems are required to be notified of the information related to the unlocking of the full version contents (step S306).

In case that an SMS billing system is involved in processing the charged fee, all of the systems need to be notified of the information (step S306).

As described above, when systems numbering more than two are involved, and process the charge fee cooperatively, the information about the charged fee for unlocking the full version contents need to be shared among the systems (for example, an identification code of the mobile device, an unlocking time, an identification code of the contents, the charged fee, a payment method for the charged fee, data related to the unlocking code, etc.).

FIG. 3 illustrates a case in which notifying all of the related systems of the unlocking of the full version contents (step S306) is performed in parallel with the actual unlocking of the full version contents (step S304). However, notifying the systems of the unlocking of the full version contents may be performed before or after unlocking the full version contents.

Hereinafter, billing for unlocking the full version contents embedded in the mobile device according to an example embodiment of the present invention will be described.

In case that the full version contents are unlocked through an SMS message, the fee for unlocking the full version contents may be billed by billing for using the SMS service. For example, when a fee for unlocking the full version contents is $1 USD, a fee of $1 USD for using the SMS service may be charged to the user.

On the other hand, the number of SMS messages that are charged to the user may be determined according to the charged fee, when the fee for using SMS is charged by the number of SMS messages used. For example, when the charged fee for using the full version contents is $1.50 USD, and the fee for using one SMS is $0.50 USD, the fee for using 3 SMS messages may be charged to the user.

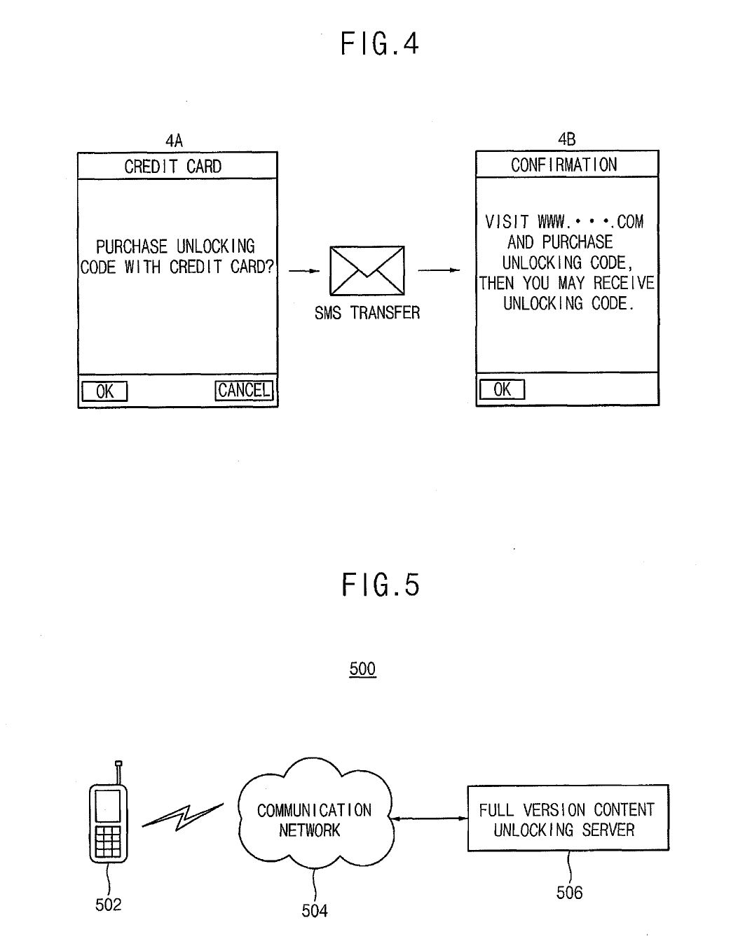

The charged fee for unlocking the full version contents may be processed by a credit card payment system instead of charging fees for the SMS service or the data communication service. Processing the charged fee through a credit card payment system will be described later in detail referring to FIG. 4.

Hereinafter, a format of messages transmitted among systems for processing the charged fee will be described.

For example, the user of the mobile device or other systems may be notified through an SMS message of the information regarding unlocking the full version contents using a format such as “MBIZ,MZTSOND900EU,2,UK,545678”. Herein, “MBIZ” represents the full version content unlocking server or intervening systems, and “MZTSOND900EU” represents specific contents. “2” represents the number of times SMS messages are used and indicates that the charged fee is for 2 messages. “UK” represents the user-selected country, which in this case is the United Kingdom. “545678” represents the unlocking code for unlocking the full version contents.

Various kinds of message formats may be used, and thus detailed descriptions of similar formats will be omitted.

FIG. 4 illustrates screens displayed in a mobile device for illustrating an interface of a credit card payment system according to an example embodiment of the present invention.

When the user of the mobile device requests unlocking of the full version contents, or the user uses demo version contents, a screen as shown in screen 4A is displayed for paying with a credit card.

When the user clicks OK, information regarding a credit card is transmitted to the unlocking server. The information regarding the credit card is required for processing the charged fee, and may be transmitted to the mobile manufacturer, the content provider, and additional billing systems as well. The information may be transmitted using SMS messages.

For example, when the user selects to pay with a credit card, the unlocking code may be stored in the unlocking server or other systems. After that, when the user completes the credit card payment, the stored unlocking code is transmitted to the user through an SMS message.

When the credit card payment request is accepted, a screen may display a web site where the user may pay with a credit card.

When the user logs on after inputting an identification code of the mobile device at the web site, and completes the credit card payment, the user may be shown the unlocking code for unlocking the full version contents. The unlocking code may be transmitted through an SMS message as described with reference to FIG. 2. Credit card payment systems on the Internet are well known to those skilled in the art. Thus, a detailed description will be omitted.

FIG. 5 is a block diagram illustrating a system configuration for unlocking full version contents embedded in a mobile device according to an example embodiment of the present invention.

Referring to FIG. 5, a system 500 for unlocking full version contents embedded in a mobile device includes a mobile device 502, a communication network 504, and a full version content unlocking server 506.

The mobile device 502 according to an example embodiment of the present invention performs functions for requesting the full version content unlocking server 506 to unlock the full version contents. The mobile device may permit the user to use the full version contents when the request is accepted.

Herein, the mobile device 502 may be configured to be enabled to use the full version contents right after receiving an unlocking message from the full version content unlocking server 506, or the mobile device 502 may be configured to be enabled to use the full version contents after the user inputs an unlocking code transmitted through an SMS message.

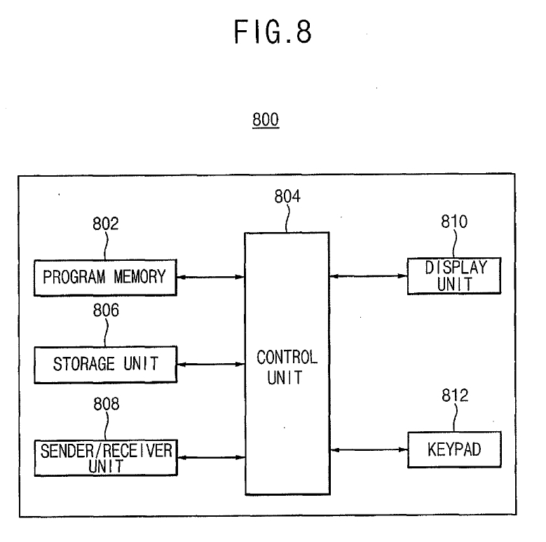

A detailed configuration of the mobile device according to an example embodiment of the present invention will be described later with reference to FIG. 8.

The full version content unlocking server 506 according an example embodiment of the present invention performs functions for permitting the user to use the full version contents embedded in the mobile device 502 when receiving the request.

Herein, the full version content unlocking server 506 may enable the mobile device 502 to use the full version contents right after receiving a request, or after an additional confirmation procedure. The full version content unlocking server 506 may also enable the mobile device 502 to use the full version contents by transmitting an unlocking code through an SMS message. The unlocking code may be generated using various methods by the full version content unlocking server 506.

The full version content unlocking server 506 according an example embodiment of the present invention may include functions related to processing a charged fee.

The communication network 504 according to according an example embodiment of the present invention provides channels for transmitting data between the mobile device 502 and the full version content unlocking server 506. Wireless channels as well as wired channels may be used.

The communication network according to an example embodiment of the present invention may be implemented using various methods, such as a wireless access network, a packet data network, code division multiple access (CDMA) 2000 1x, CDMA 2000 1x EV-DO, a telephone, a modem, or the Internet.

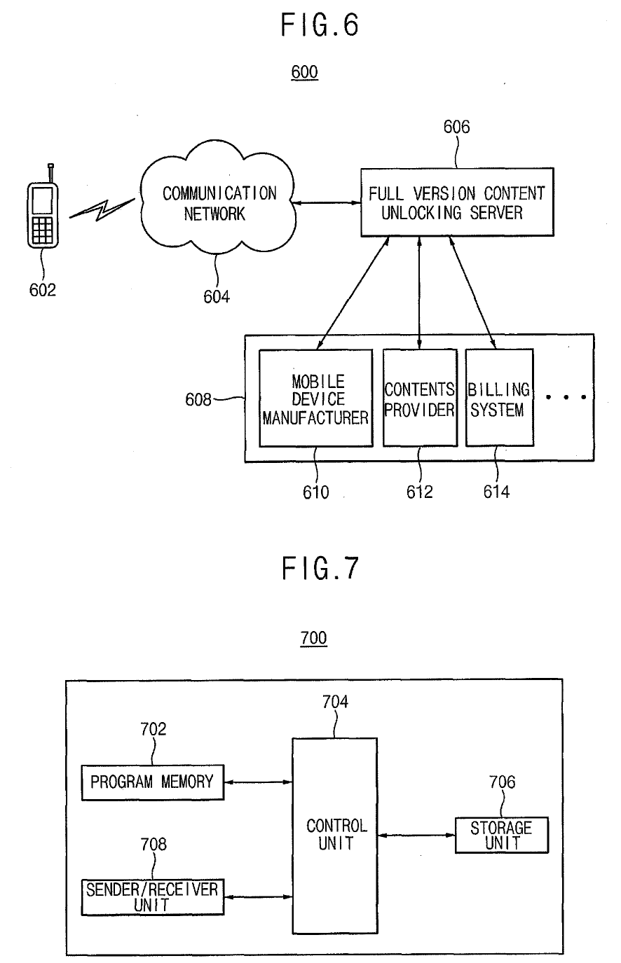

FIG. 6 is a block diagram illustrating another system configuration for unlocking full version contents embedded in a mobile device according to an example embodiment of the present invention.

Referring to FIG. 6, a system for unlocking of the full version contents embedded in a mobile device 600 includes a mobile device 602, a communication network 604, a full version content unlocking server 606, and a third systems 608.

The systems for unlocking the full version contents embedded in the mobile device according to an example embodiment of the present invention are basically similar to the systems shown in FIG. 5 except for additional third systems 608.

The third systems 608 according to an example embodiment of the present invention may include a mobile device manufacturer 610, a content provider 612, and a billing system 614.

As described in FIG. 3, when systems numbering more than two are involved, and process the charge fee cooperatively, the information about the charged fee for unlocking the full version contents need to be shared among the systems. FIG. 6 illustrates a case in which the full version content unlocking server 606 intervenes among the mobile device manufacturer 610, the content provider 612, and the billing system 614.

That is, the full version content unlocking server 606 transfers the information regarding the charge fee to the various systems among the mobile device manufacturer 610, the content provider 612, and billing system 614, as well as performs the functions described in FIG. 5.

The billing system 614 processes the charged fee; for example, the billing system 614 manages various fees for usage of intervening systems, such as usage of the full version content unlocking server 606 by the mobile device manufacturer 610 or the content provider 612.

The billing system 614 is included in the third systems 608 in FIG. 6. The billing system 614 may be included in the communication network 604 like a Short Message Service Center (SMSC), or may be included in the full version content unlocking server 606.

The full version content unlocking server 606 may be configured inside the mobile device manufacturer 610 or the content provider 612 instead of independently from the third systems 608.

FIG. 7 is a block diagram illustrating a configuration of a full version content unlocking server according to an example embodiment of the present invention.

Referring to FIG. 7, a full version content unlocking server 700 includes a program memory 702, a control unit 704, a storage unit 706, and a sender/receiver unit 708.

The program memory 702 stores a full version content unlocking program having functions to receive requests for unlocking the full version contents and send an unlocking signal. The full version content unlocking program may include functions for performing confirmation procedures, processing charged fees, intervening in the unlocking of full version contents cooperatively with third systems 608.

The control unit 704 controls functions for executing the full version content unlocking program. The storage unit 706 stores control data needed for controlling by the control unit 704, and other related information.

The sender/receiver unit 708 transfers data though the communication network in accordance with control by the control unit 704.

FIG. 8 is a block diagram illustrating a configuration of a mobile device according to an example embodiment of the present invention.

A concept of a mobile device 800 according to an example embodiment of the present invention may include various wireless communication means, such as personal digital assistant (PDA) cellular phones, Personal Communications Service (PCS), Global System for Mobile Communications (GSM), wideband CDMA (W-CDMA), CDMA2000, and Mobile Broadband System (MBS).

Referring to FIG. 8, the mobile device 800 according to an example embodiment of the present invention includes a program memory 802, a control unit 804, a storage unit 806, a sender/receiver unit 808, a display unit 810, and a keypad 812.

The program memory 802 stores a full version content activation program having functions to send a request signal for unlocking the full version contents and receive an unlocking signal. Only the demo version contents are available before the unlocking. The full version content activation program may enable the full version contents after receiving the unlocking signal. Moreover, various functions, such as language selection, or confirmation of the unlocking code, may be further included.

The control unit 804 controls functions for executing the full version content activation program. The storage unit 806 stores the full version contents, controls data needed for controlling by the control unit 804, and other related information.

The sender/receiver unit 808 transfers data though the communication network in accordance with control by the control unit 804.

A user of the mobile device 800 may request unlocking of the full version contents by using the keypad 812.

A display unit 810 displays menus needed for unlocking procedures as shown in FIG. 2 in accordance with control by the control unit 804.

### INDUSTRIAL APPLICABILITY

According to a method and system for unlocking full version contents, a user of a mobile device initially uses demo version contents. The full version contents are only unlocked after requesting the unlocking, and costs for the full version contents are charged to the user only when the request is allowed. Thus, costs may be saved.

The full version contents may be used easily and conveniently by the user selecting a language and the full version contents being unlocked through a short message service (SMS) message.

Security and management efficiency may be increased by using an unlocking code and cooperating with other systems for processing a charge fee.

The present invention provides a method and system for unlocking the full version contents embedded in a mobile device, and the method may be conveniently used by the user, and may efficiently provide security and management.

While the present invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

1-18. (canceled)

19. A server for unlocking full version contents embedded in a mobile device, comprising:
a memory for storing a full version content unlocking program, the full version content unlocking program comprising functions of receiving a first signal for requesting the unlocking of full version contents, and sending an unlocking message having an unlocking code for permitting a user to use full version contents, of which permitted usage is initially limited;
a control unit for controlling the functions of the full version content unlocking program;
a storage unit for storing control data of the control unit, and data needed for unlocking the full version contents; and
a sender/receiver unit for transmitting data through a communication network in response to the control unit, wherein the full version content unlocking program further comprises functions of processing a charged fee for using the full version contents,
the unlocking message is delivered through a short message service (SMS) message,
the charged fee is processed by billing for the SMS message, and
the number of unlocking SMS messages that are charged to the user is determined according to the charged fee for unlocking the full version contents.

20-25. (canceled)

26. The server of claim 19, wherein the unlocking message is transmitted based on a specific language selected by the user for the sake of convenience.

27. The server of claim 19, wherein the unlocking program further comprises functions of unlocking full version contents based on a response signal to the unlocking message.

28. The server of claim 27, wherein the response signal comprises a signal for notifying that the user inputs the unlocking code for unlocking the full version contents.

29. The server of claim 28, wherein the number of times the user is permitted to attempt to input the unlocking code is limited to a specific number.

30. The server of claim 19, wherein the full version content unlocking program further comprises functions of generating a second signal having information about the charged fee, and sending the second signal.

31. The server of claim 30, wherein the second signal comprises at least one selected from the group consisting of an identification code of the mobile device, an unlocking time, an identification code of the contents, the charged fee, a payment method for the charged fee, and data related to the unlocking code.

32. The server of claim 30, wherein the second signal is transmitted to at least one selected from the group consisting of the mobile device, a mobile device manufacturer, a content provider, and a billing system.

33. A mobile device comprising:
a memory for storing a full version content unlocking program, the full version content unlocking program comprising functions of sending a first signal for requesting the unlocking of full version contents, and receiving an unlocking message having an unlocking code for permitting a user to use full version contents, of which permitted usage is initially limited;
a control unit for executing the full version content unlocking program;
a storage unit for storing the full version contents, control data of the control unit, and data needed for unlocking the full version contents;
a sender/receiver unit for transmitting data through a communication network in response to the control unit;
a keypad configured to manipulate a menu for requesting the unlocking of the full version contents; and
a display unit for displaying input information of the menu, and the unlocking message for unlocking the full version contents, wherein the full version content unlocking program further comprises functions of processing a charged fee for using the full version contents,
the unlocking message is delivered through a short message service (SMS) message,
the charged fee is processed by billing for the SMS message, and
the number of unlocking SMS messages that are charged to the user is determined according to the charged fee for unlocking the full version contents.

34. (canceled)

35. The mobile device of claim 33, wherein the user of the mobile device may select a specific language for the sake of convenience.

36. The mobile device of claim 33, wherein the full version contents are enabled to be used by the unlocking code inputted through the keypad.

37. The mobile device of claim 36, wherein the number of times the user is permitted to attempt to input the unlocking code is limited to a specific number.

38. A method for unlocking full version contents embedded in a mobile device, comprising:
(a) sending a first signal for requesting the unlocking of full version contents embedded in a mobile device, the full version contents of which permitted usage is initially limited; and
(b) receiving an unlocking message having an unlocking code for permitting a user to use the full version contents, wherein the full version content unlocking program further comprises functions of processing a charged fee for using the full version contents,
the unlocking message is delivered through a short message service (SMS) message,
the charged fee is processed by billing for the SMS message, and
the number of unlocking SMS messages that are charged to the user is determined according to the charged fee for unlocking the full version contents.

39. (canceled)

40. The method of claim 38, further comprises:
(c) permitting the user to use the full version contents based on the unlocking code inputted by the user.

41-42. (canceled)
